(19) United States
(12) Patent Application Publication
(10) Pub. No.: US 2008/0046315 A1
(43) Pub. Date: Feb. 21, 2008

(54) Realizing revenue from advertisement placement

(75) Inventors: Brian Axe, San Francisco, CA (US); Smita Hashim, Saratoga, CA (US)

Correspondence Address: FISH & RICHARDSON P.C., PO BOX 1022, MINNEAPOLIS, MN, 55440-1022, US

(73) Assignee: Google, Inc., Mountain View, CA (US)

(21) Appl. No.: 11/505,317

(22) Filed: Aug. 17, 2006

(51) Int. Cl. G06Q 30/00

(52) U.S. Cl. 705/14

(57) ABSTRACT

Realizing revenue from publication-based advertisement placement. Publisher's request advertisements for unallocated ad space in their publications through an advertiser portal interface. The advertising portal interface includes a database of advertiser information. An ad copy is created containing the advertiser information selected by the publisher. The ad copy contains a URL of a website on the portal created for the publisher containing electronic versions of the selected advertisements. The website also contains click-through links to each of the represented online retailers thereby enabling realization of advertising revenue for both the publisher and portal for click-through referrals to advertiser websites.

### FIELD OF THE INVENTION

The present invention relates to print and electronic advertising and more particularly to realizing revenue from publication-based advertisement placement using a publisher interface to an advertising server portal.

### BACKGROUND OF THE INVENTION

A major obstacle for publishers of paper media and even online publications is designing publication layout. Formulating layout is a labor intensive process that requires significant lead time to determine where articles and advertisements will appear. Often, publication layout is dictated by advertising commitments including size and location requirements of ad copy. In the process of meeting these commitments, publishers are often left with a certain amount of unallocated space. To fill this unallocated space, publishers may extend article lengths, include additional photographs, shorten publication length and even insert advertising placeholders such as “Your ad here.” All of these solutions cost publishers money in terms of lost advertising revenue. Because layout decisions must be made prior to each publication, it is often difficult for advertiser to sell this “last minute” advertising space. Advertisers typically purchase advertising space as part of a planned campaign rather than spontaneously. As a result, publishers may be left with unallocated ad space that could otherwise be occupied with paying ads. Though publishers may be willing to accept less revenue for this space, because of the time involved in selling and creating ads it may be more difficult to market on short notice.

Online advertisers tend to be more dynamic because of the speed with which a website can be created and the relative ease of changing electronic ads and hyperlinks. However, in published media, ad space is sold on a cost per impression basis (that is based on an assumption that a fraction of the magazine's total circulation views the ad). This type of advertising is usually very expensive because the ad is presented to the publication's entire circulation. Online advertisers are accustomed to purchasing ad space on a referral or cost-per-click basis. These advertisers may be reluctant or even unable to purchase ad space on a cost-per-impression basis (i.e., appearance in a publication based on circulation figures) because of the relatively large expense and inability to measure quantify effectiveness.

### SUMMARY OF THE INVENTION

Accordingly, at least one exemplary embodiment may provide a method of realizing revenue from publication-based advertisements. The method according to this embodiment may comprise providing a publisher interface adapted to permit selection of advertising information, receiving a selection of advertising information, providing the selected advertising information, including an identifier for the advertising information, and tracking each time a viewer contacts an advertiser using the identifier.

In another exemplary embodiment, a system for realizing click-through revenue from publication-based advertisements may be provided. The system according to this embodiment may comprise an advertising server adapted to provide a publisher interface adapted to permit selection of advertising information, transfer the advertising information to the publisher to be incorporated into a publication advertisement message, the publication advertisement message including an identifier, and track viewer a referral from the publication advertisement message to an advertiser using the identifier.

Yet another exemplary embodiment may provide an automated method for selling click-through referral-based advertising in published media. The method according to this embodiment may comprise creating a database of advertisers, receiving a request for advertisement information associated with a particular category, providing a list of advertisement information based on the request, receiving a selection of advertisement information from the list, generating an advertisement message containing information corresponding to the selection, transferring the advertisement message along with a network for the advertisement message, generating electronic content at a location specified by the network identifier that contains the information corresponding to the selection, and tracking a number of times viewers of the electronic content contact advertisers from the electronic content.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a system level block diagram illustrating components of an automated system for realizing click-through referral-based advertisement revenue from publication-based advertisement placement according to at least one embodiment of the invention;

FIG. 2 is a block diagram illustrating the various components of an advertising server for realizing click-through referral-based advertisement revenue from publication-based advertisement placement according to at least one embodiment of the invention;

FIG. 3 is a flow chart detailing the steps of an automated method for realizing click-through referral-based advertising revenue from publication-based advertisement placement according to at least one embodiment of the invention;

FIG. 4 is a flow chart detailing the steps of a method for providing a publisher interface to permit advertisement information selection in accordance with at least one embodiment of the invention;

FIG. 5 is a flow chart detailing the steps of a viewer interaction with a publisher's advertisement web page and click-through revenue realization according to at least one embodiment of the invention;

FIG. 6 is an exemplary user interface screen shot of a publisher interface to an advertising server for selecting one or more advertisements according to according to at least one embodiment of the invention;

FIG. 7 is a sample publication advertisement message including information taken from ad portal-based advertisers according to at least one embodiment of the invention; and

FIG. 8 is an exemplary user interface screen shot illustrating an exemplary view of a publisher's advertisement content page according to at least one embodiment of the invention.

### DETAILED DESCRIPTION

The following description is intended to convey a thorough understanding of the embodiments described by providing a number of specific embodiments and details involving systems and methods for realizing click-through referral-based advertisement revenue from publication-based advertisement placement. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Related U.S. patent application Ser. No. 11/394,209 filed Mar. 31, 2006 and entitled “Allocating and Monetizing Advertising Space in Offline Media Through Online Usage and Pricing Model,” is hereby incorporated by reference in its entirety

### System Overview

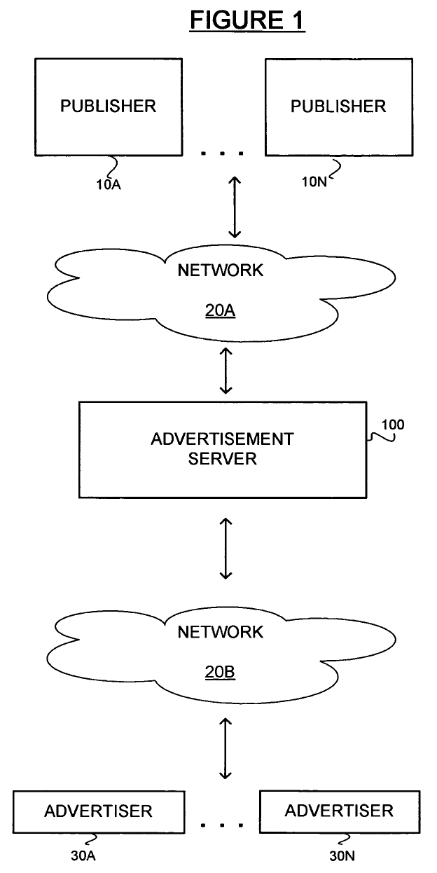

Referring now to FIG. 1, a system level block diagram illustrating components of an automated system for realizing click-through referral-based advertisement revenue from publication-based advertisement placement according to at least one embodiment of the invention is illustrated. The system comprises a plurality of publishers 10A to 10N in electronic communication with an advertising server 100 over a communication network 20A. As is discussed herein, the publishers 10A to 10N may comprise traditional paper media publishers such as magazine, journal, and newspaper publishers, many of whom also publisher online versions of their publications. Publishers 10A to 10N may also be online only publications or mixtures of offline and online publishers. In various embodiments the communications network 20A may be a wide area public network such as the Internet. However, the communications network 20A may also be a telephone network, local area network (LAN), wide area network (WAN), ad-hoc network, or other suitable network. Although the advertising server 100 is depicted as single block in the figure, as will be discussed in greater detail herein, it may comprise multiple distributed system components.

The system of FIG. 1 also comprises one or more advertisers 30A to 30N, also in electronic communication with the advertising server 100 over a communication network 20B. The advertisers 30A to 30N may comprise various goods and services provides who maintain their information with the advertising portal associated with the advertising server 100. In various embodiments, each of the advertisers 30A to 30N may maintain an Internet website and the advertiser server 100 may store the address of each advertiser's Internet website along with other identifying information such as name, address, telephone number, and/or types/categories of goods services offered by the advertiser. In various embodiments, the advertisers 30A to 30N may pay to have their names associated with one or more keywords or categories. In various embodiments, the network 20B may be the same network as network 20A, such as, for example, the Internet. However, those of ordinary skill in the art should appreciate that the networks 20A and 20B do not have to be the same network.

In the system of FIG. 1, as will be discussed in greater detail herein, advertisers 30A-30N may interact with the advertising server 100 to purchase and pay for advertisements, to upload advertisement messages and/or other identifying information, as is discussed in greater detail in the aforementioned application, U.S. patent application Ser. No. 11/394,209. It should be appreciated that as used herein, the term “advertisement messages” will refer to any document, data set or other object that identifies a retailer or brand owner and that refers to at least one product, service, class of products and/or class of services. In various embodiments, advertisers may create their own advertisement messages and upload them to the advertising server. However, in various embodiments, the advertisement messages may be created automatically, manually or through a mixture of automated and manual processes at the advertising server 100 side using information supplied by the advertisers 30A-30N. Furthermore, as used herein, the phrase “advertising copy” or “ad copy,” will be used to refer to the actual layout, that is visual appearance of an advertisement message, and may be used synonymously with the phrase “advertising message.”

With continued reference to FIG. 1, publishers 10A to 10N may interact with the advertising server 100 to request and obtain advertisements to fill available advertising space in their respective publications. As used herein, publications may include newspapers, magazines, television, or any other suitable print and/or online media source. As will be discussed in greater detail herein, in various embodiments, the publishers 10A to 10N may query a database of advertiser information accessed via the advertiser server 100 to search for advertisers who are relevant to the particular publication or desired advertising category. In various embodiments, the publishers 10A to 10N may select one or more advertisers from the query results. In various embodiments, the publishers 10A to 10N may specify an amount (i.e., physical dimensions, number of spaces, number of pages, etc.) of available advertising space and the server 100 may provide information corresponding to one or more advertisers to fill the available space. In various embodiments, the advertising server 100 may format the advertiser information to fit in the available space. In various embodiments, the requesting publisher may format the advertiser information into an advertisement message.

Though not depicted in FIG. 1, those of ordinary skill in the art will appreciated that a plurality of potential publication viewers may also interact with the advertising server such as by viewing one or more web pages associated with the server via networks 20A and/or 20B. For example, if one or both of networks 20A and 20B are the Internet, publication viewers may interact with the advertising server 100 via web browser clients on their respective computer systems, such as the now ubiquitous INTERNET EXPLORER, NETSCAPE NAVIGATOR and FIREFOX browser clients offered by Microsoft Corporation of Redmond, Wash., Time Warner of New York, N.Y., and the Mozilla Foundation, of Mountain View, Calif., respectively. Those of ordinary skill in the art will appreciate that computer systems may include traditional desktop and laptop computer systems as well as PDAs, mobile phones, BLACKBERRY devices, and other portable communication devices. These devices all typically include some form of browser client than enables a person to view content from the Internet. Browser may include HTTP browsers (based on the hypertext transfer protocol), such as the aforementioned INTERNET EXPLORE, NETSCAPE NAVIGATOR AND FIREFOX, as well as WAP browsers (based on the wireless application protocol), or other suitable browser based on currently known or previously un-standardized Internet protocols.

### Exemplary System Architecture

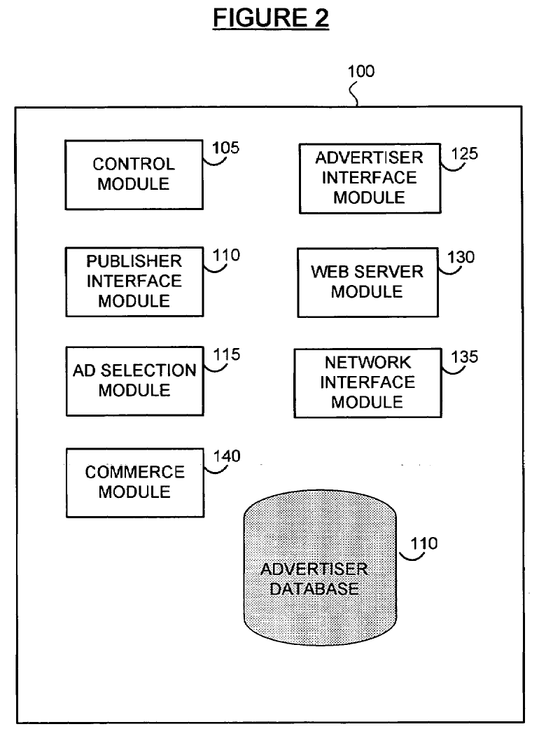

Referring now to FIG. 2, an exemplary system architecture for an advertising server for realizing click-through referral-based advertisement revenue from publication-based advertisement placement according to at least one embodiment of the invention is depicted. The server 100 may comprise a plurality of different modules and database(s) which, in various embodiments, may provide functionality that enables the system to serve as a platform for commerce between publishers, advertisers, consumers and the ad server. The exemplary architecture depicted in FIG. 2 includes a control module 105, a publisher interface module 110, advertiser selection module 115, an advertiser database 120, an advertiser interface module 125, a web server module 130, a network interface module 135, and a commerce module 140. It should be appreciated that each module may be configured as a circuit, routine or application, as a software application executing on computer hardware, an application specific integrated circuit (ASIC), a combination of hardware and software, or other suitable configuration. Moreover, modules may be combined or broken into multiple additional modules. For example, the control module 105 may be one or more CPUs of the server 100, may be a DSP, or even an embedded processor and/or embedded operating system.

The network interface module 135 may comprise a network interface card, modem, wireless transceiver or other network device and corresponding device drivers may enable two-way communication between the advertising server 100 and publishers, and advertisers and consumers (ad viewers). In various embodiments, advertisers may supply advertisement messages and/or other advertiser information and may specify pricing and context criteria to the advertisement server using the advertiser interface module 125. In various embodiments, pricing may be based on a bid per click-through or bid per N click-through referrals model, such as per 1000 click-through referrals. In various embodiments publishing companies may interact with the advertising server 100 via the publisher interface module 110 to submit requests for advertisements to occupy a specified volume of unallocated space in their publications, to search the advertiser database 120 for advertisers meeting a particular criteria and to download selected advertiser information. As noted herein, in various embodiments, publishers may receive formatted advertiser information from the advertising server 100. In various embodiments, publishers may only receive advertiser information that must be formatted by the publisher into an advertisement message for inclusion in the publisher's publication.

The publisher interface module 110 may serve as the primary interface between publishers wishing to fill unallocated advertising space and the advertising server 100. In various embodiments, the publisher may log on to the advertising server 100 by sending an electronic message, or navigating to a website associated with the advertising server 100 and submitting a request via the publisher interface module 110. Through the publisher interface module 100, the publisher may supply information relating to the category, amount and/or quality of unallocated advertising space they are seeking to fill. After the request has been received, in various embodiments, the ad selection module 120 may, based on the information supplied by the publisher and information already supplied by various advertisers, search the advertiser database 120 for one or more advertisers who match the search criteria. In various embodiments, advertisers may specify that they be associated with one or more keywords and/or categories so that when a publisher specifies advertisements relevant to that keywords or category, those advertisers are returned. The database may store advertisers' names and contact information and/or may store advertising messages, images and other related information. The selection may be based on any of a number of factors including the type of publication, the particular context of the advertisement (i.e., publication section, such as travel), amount and/or quality of available space, pricing constraints of the advertiser, previously specified advertiser preferences and/or variations of any of these factors. Once the publisher has selected one or more advertisers presented by the ad selection module 115, in various embodiments, the publisher interface module 110 may transfer the corresponding information for the selected advertisers to the requesting publisher. In various embodiments, this may comprise creating an ad copy layout including advertising messages from the one or more selected advertisers that is of the approximate size and shape specified by the offline media source. However, it should be appreciated that in some embodiments, the publisher may generate the ad copy based on information about the selected advertisers supplied by the advertising server 100. In various embodiments, the network interface module 135 is used to transmit the selected advertiser information and/or ad copy to the requesting publisher. In various embodiments, a notation may be made in the commerce module of the fact that the advertiser may be referenced in the publisher's publication, resulting in potential click-through referrals from a web page created by the web server module for the publisher.

In various embodiments, once the publisher has selected one or more advertisers to feature in their publication, the web server module may create a web page at a web address that is specific to the publisher. This may comprise creating an HTTP-based content page, a WAP-based content page or other protocol-based content page. In various embodiments the address of this web page may print with the selected advertiser information in the publisher's publication, thereby directing viewers to the web page to obtain additional information corresponding to the published advertisement message. This web page may contain an online version of the advertisement message appearing in the publication—that is, the ad message on the web page may feature the advertiser information selected by the publisher from the ad server. The web page may also include additional advertiser information deemed to be relevant to the category or type of advertisers featured in the published advertisement message, thereby providing viewers with more detailed choices than would have been available in a size-limited publication advertisement, thus, mimicking an online search experience for the viewer. In this manner, persons viewing the ad who wish to gain additional information regarding the advertised products and/or services may have to go to the publisher's publication web page in order to obtain this additional information. In various embodiments, this web page may include electronic hyperlinks to websites affiliated with each of the advertisers represented therein, a telephone number, an email address, or other contact information. When a person viewing the online replica site selects one of these hyperlinks, the ad commerce module 140 can confirm that an effective click-through referral from the publisher to the advertiser via the ad server has occurred and can charge the particular advertiser according to its predetermined pricing plan, such as for example on a cost per click-through referral basis.

It should be appreciated that in addition to creating a web page, or alternatively, the advertising server 100 may also establish another advertiser information channel for the publisher including, but not limited to a telephone line, a streaming content site for downloading digital content related to the publication's advertisement, a television channel, downloadable television content, or other media channel.

In various embodiments, advertisers may interface with the advertising server 100 through the advertiser interface module 125. Through this module advertisers may upload advertising messages and/or other preference and identification information, may set up payment methods and specify pricing models and may supply other information. In various embodiments, publishers may be transparent to advertisers. For example, in various embodiments, the advertisers may advertise with the advertising server for traditional Internet-based advertising. In various embodiments, the ad server may be associated with a web content portal such as GOOGLE, YAHOO, MSN, etc. Generally, in this situation, advertisers are only concerned with getting referrals, rather than how they are generated. Thus, the advertiser's pricing and association information need not reference publication advertisements. Rather, the ad server may take advantage of existing advertising agreements with the advertiser when providing advertiser information to publishers. In various embodiments, the advertiser-specified information may also be stored in the advertiser database 120 or other database and may be used by the ad selection module 115 to assist in determining which ad messages to select in response to a publisher request and/or query.

It should be appreciated that each module depicted in the server 100 may operate autonomously or under the control of the control module 105. For example, in various embodiments, the control module may be a CPU of the server 100. Furthermore, it should be appreciated that the particular modules illustrated in FIG. 2 are exemplary only and should not be construed as either necessary or exhaustive. In various embodiments, it may be desirable to use more, less or even different modules than those illustrated in FIG. 2. It should also be appreciated that the advertising server 100 may also be configured as more than one server or a distributed network of servers and that the advertiser database 120 may actually be located remote from the server 100 and accessible over a network. In various embodiments, access to the advertiser database 120 may occur in real or near real time so that publishers can get a response sufficiently quickly to permit them to incorporate the selected advertisers in their publications prior to publication.

### Exemplary Targeted Marketing Process

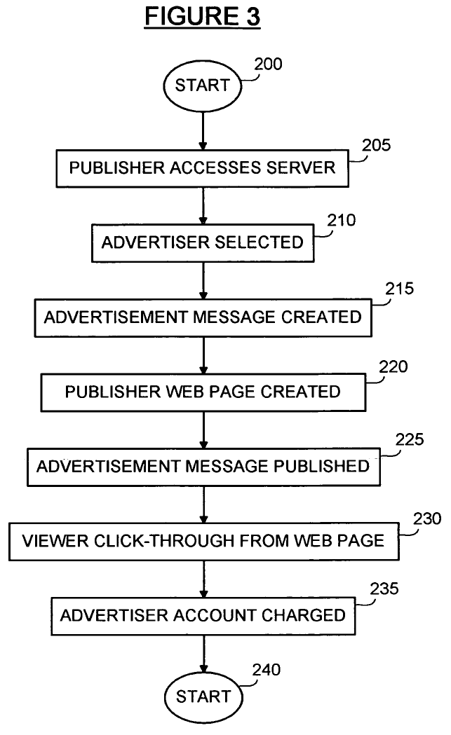

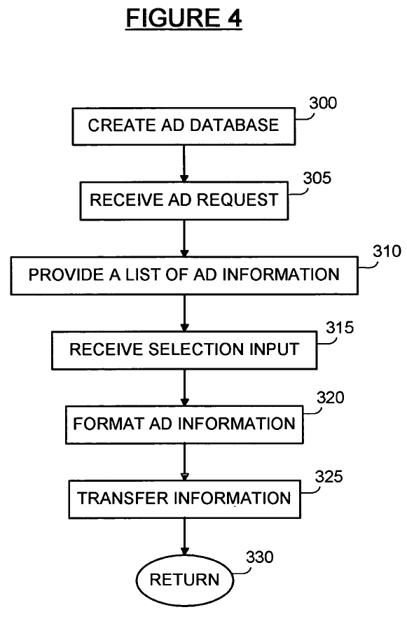

Referring now to FIG. 3, a flow chart detailing the steps of an automated method for realizing click-through referral-based advertising revenue from publication-based advertisement placement according to at least one embodiment of the invention is depicted. The method begins in block 200. In block 205, a publisher accesses the advertising server to request and/or search for advertisers to include in the publisher's publication. As discussed herein, in various embodiments, this may comprise submitting an electronic request specifying an amount and/or type of advertiser desired, or performing a query of the advertiser database using one or more key words and/or concepts. In various embodiments, this may also comprise receiving a request from a publisher for advertisements to fill unallocated space in the publisher's publication. The request may be received as an electronic mail message, a web form, telephone call, facsimile, etc. The request may be processed automatically or be completed through human data entry or combinations of these methods. In various embodiments, as will be discussed in greater detail in the context of FIG. 4, the request may include information such as data fields that specify the type or category of advertisers relevant to the particular placement in the publication, the nature of the publication itself, the amount of available advertiser space (i.e., physical dimensions, number of openings, number of pages, etc.), expected price, exclusions (i.e., based on exclusive agreements with other advertisers already present in the publication) and other suitable information. As discussed herein, in various embodiments, the advertising server may maintain a database of available advertisement messages, or simply a database of advertisers with one or more fields describing their product or service and identifying them by name and/or with contact information. In various embodiments, advertisers may specify that they be associated with one or more keywords, contexts, etc., so that a query using any of these keywords or context may return at least the advertiser who has specified the association.

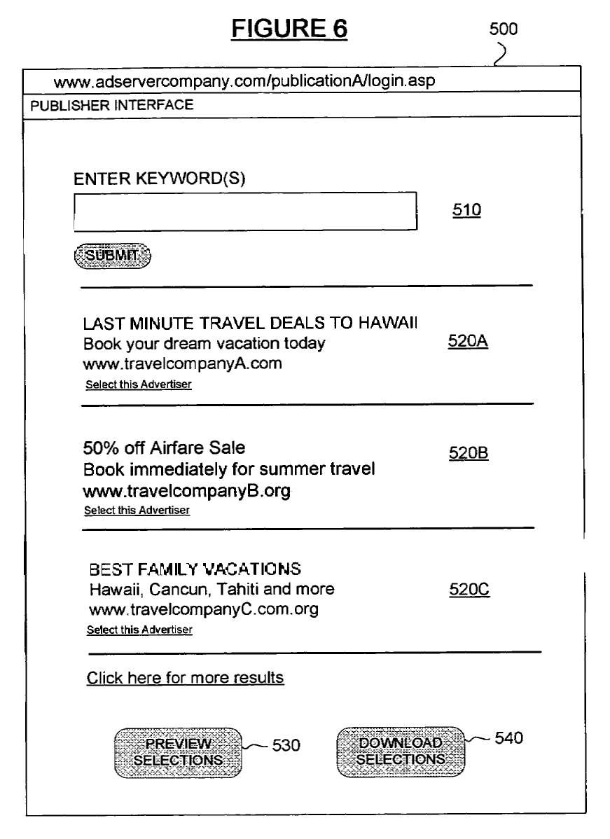

In block 210, the publisher selects one or more advertisers. In various embodiments the publisher may make the selection using an automated technique analogous to an electronic shopping cart. For example, as illustrated in the context of FIG. 6, a link may be provided near each listed advertiser in the publisher's interface, the link permits the publisher to add a particular advertiser to a selection list and then “checkout” (or complete selection of) all the selections. However, it should be appreciated that other selection techniques may be employed. In general, selecting may comprise receiving at the advertiser server an indication of advertising information, for example, a particular advertisement or advertisements, a particular advertiser, or advertisers, a category of desired advertisement and/or advertiser information, and combinations of these.

In block 215, after one or more advertisers have been selected, the advertisement message for the publication is created. In various embodiments, the advertisement server may create the advertisement message automatically based on the advertiser(s) selected by the publisher and other information supplied by the publisher such as the size of the available space. In such embodiments, the publisher may download a complete ad message in the form of an electronic document, image, etc. In various embodiments, the ad server may merely supply one or more fields of information corresponding to the selected advertiser(s) and the publisher may create the advertisement message using this information. In various embodiments, the advertising server may redact one or more identifying fields from the advertiser information, such as, name, telephone number, website address, etc., in order to prevent viewers of the published advertisement message from contacting the selected advertisers directly, thereby bypassing the click-through referral-based revenue mechanism provided by the various embodiments of the invention. In various embodiments, the advertising server may supply all the information fields corresponding to the selected advertiser(s) and the publisher may be responsible for selecting those fields that are desired and for removing any identifying information. In various embodiments, along with the selected advertiser information, the advertising server may supply the publisher with a web page address unique to that publisher's publication. In various embodiments, this address may be included in the published message along with the information corresponding to the selected advertiser. This web page may serve as a portal for viewers of the publication to obtain more information related to the published ad message.

In blocks 220 and 225, the publisher web page may be created and the advertisement message is published in the publication. The particular order of these events is not critical to the various embodiments of the invention. In various embodiments, the publisher web page may include all the available information corresponding to the advertisers selected by the publisher and included in the ad message, as well as information corresponding to other advertisers whose information is stored on the ad server and whose products/services are contextually relevant to those selected by the publisher. In various embodiments, the web page may include a search interface for the user to refine a search of the presented advertisers or to search for new ones. In this manner, the viewer may be able to achieve the type of sophisticated querying and detailed results that they have become accustomed to on the Internet, while the publisher and ad server portal may be able to expand revenue generating opportunities beyond those possible from the few advertisers selected to appear in the publication.

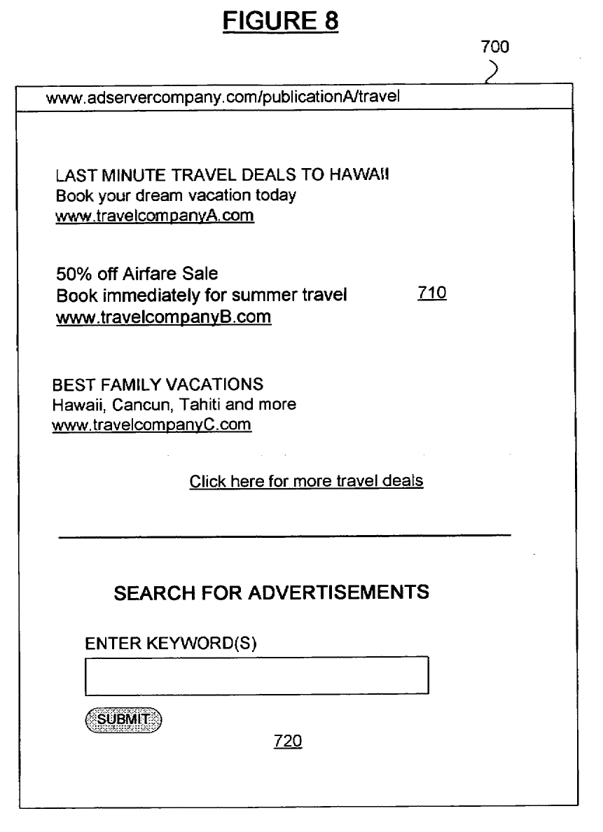

In block 230, a viewer visits the web site that appears in the published ad message seeking additional information on the selected advertisers. In various embodiments, in the case of paper media, this may comprise the viewer entering the URL of the webpage cited in the ad message. In the case of online publications, this may comprise selecting the advertisement, which, may include an automatic hyperlink to the publisher's publication web page associated with the ad server. As is discussed in greater detail in the context of FIG. 8, in various embodiments, the advertiser information on the web page may include all or at least more of the available advertiser fields, such as a hyperlink to a website affiliated with each advertiser. The user may use this hyperlink to click-through from the publisher's web page to the selected advertiser's website. If this click-through occurs, in block 235, the advertiser's account with the ad server is updated to reflect another click-through referral provided by the advertising server. In various embodiments, when the viewer clicks through to the advertiser's website, a cookie is set in the cookie file of the user's web browser to reflect the visit, thereby preventing the advertiser from being charged if the viewer, through execution of his/her browser, navigates from the publisher's page to the advertiser's page multiple times in the same session. In various embodiments, either the advertiser or the ad server may specify a length of time for such cookies to remain active, thereby barring subsequent click-through referrals. As discussed herein, it is common for advertisers to pay for fixed fee for X number of click-through referrals, such as, for example, per 1000. The method stops in block 240.

Referring now to FIG. 4, a flow chart detailing the steps of a method for providing a publisher interface to permit advertisement information selection in accordance with at least one embodiment of the invention is depicted. The process is initiated at block 300, where, as in block 205 of FIG. 3, a database of advertiser information is created. In various embodiments, this may comprise receiving advertisement messages, advertiser information, specific offers for goods and/or services, keyword and/or concept associations, pricing information, other information corresponding to advertisers, and combinations of any of these. In block 305, a request for advertising information is received. In various embodiments, this may be initiated by a publisher logging in to the advertising server. In various embodiments, a web server will provide the primary interface for receiving requests for advertising information. In various embodiments, the received request will comprise specified criteria such as an amount of desired advertising space, a number of units of desired advertising, a category of goods and/or services, a desired revenue amount, one or more keywords, one or concepts, and/or combinations of these. For example, the publisher may supply an amount (size, number of pages, units, etc.), a context (i.e., travel, business services, local, etc.), or other relevant information relating to the available advertising space in the requestor's publication. Receiving a request for advertisement information may also comprise receiving an advertisement server query request. In various embodiments the requester may query the database directly using one or more key words and/or contexts. In various embodiments the ad server may perform the query based on advertiser specified information. In various embodiments, the process may begin by determining which advertisers or ad messages are not excluded—conversely, which are relevant and able to meet the request. In various embodiments, this may comprise filtering the set of advertisers or advertising messages stored on the server based on the kind of publication for which the ads are intended, pricing constraints imposed by either the publisher or the advertiser, or other advertiser and/or media source preferences. In various embodiments this may result in a subset of potential advertisers or messages that is less than the total number stored on the server. In various embodiments, an algorithm, routine or criteria may be applied that maximizes potential advertisement revenue. This may comprise a pure price auction whereby advertisers who have previously specified a range or maximum amount they are willing to pay for advertising are ranked.

In block 310, a list of advertisement information is provided to the requestor. In various embodiments, this may comprise outputting advertisement information matching one or more of the requestor's criteria. This may comprise a list of advertisers, a list of advertisement messages, or other advertisement information. In various embodiments the results may be output to a display. In other embodiments, the results may be downloaded, emailed, or otherwise made available to the requesting party. In block 315, the server receives a selection input. In various embodiments, this may comprise receiving a selection indication from the requestor for some of the advertisement information provided in block 310. In block 320, the selected advertiser information is formatted. In various embodiments this may comprise selecting one or more non-identifying fields corresponding to the selected advertiser including any graphics, logos or other ad related information supplied advertisers to the ad server. In various embodiments, this comprises formatting the selected advertisers into a format matched to the dimensions supplied by the publisher. In various embodiments, this may comprise generating a field delimited list of advertisers selected by the publisher to be converted by the publisher into a suitable ad copy. In block 325, the formatted advertiser information is transferred to the publisher. In various embodiments, this comprises a file download, an electronic mail attachment, FTP process, or other suitable transfer process. In various embodiments a physical media containing the formatted advertiser information may be mailed, couriered or otherwise transferred to the publisher. The method stops in block 330, where operation returns to the process of FIG. 3.

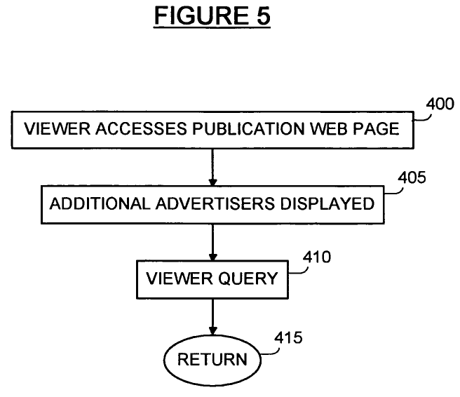

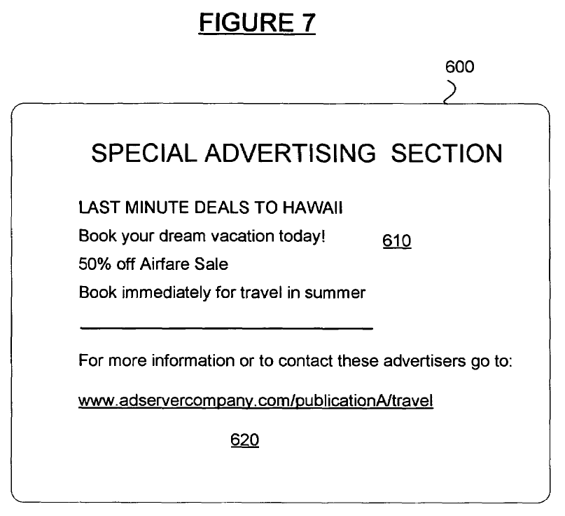

Referring now to FIG. 5, a flow chart detailing the steps of a viewer interaction with a publisher's advertisement web page and click-through revenue realization according to at least one embodiment of the invention is depicted. Operation begins in block 400. In block 400 a viewer access the publication web page created by the advertising server for the particular publisher. In various embodiment this comprises the viewer typing in the address of a web page URL appearing in the published advertisement, such as depicted in FIG. 7. In various other embodiments, this may comprise clicking on an advertisement in an online publication. For example, many publishers now maintain online versions of their publications, or in some cases maintain websites that are distinct from their other media channels. In such cases, because the viewer is already using his/her web browser to view the publication it is not necessary for the viewer to enter the web address. Rather, a hyperlink may be embedded in an advertisement text, graphic or other visual that automatically directs the user to the ad server's web page for that publication either in a current browser window or in a new browser window.

In block 405, when the user loads the publication's web page, the ad server may supply more detailed information corresponding to advertiser(s) featured in the published ad message. For example, the actual names of the advertisers selected by the publisher may be displayed. Thus, if the published ad message stated “discount airfare,” the particular advertiser who uses that ad language may be displayed, including a link to that advertiser's web site. In addition, because publication space is limited, only a few ads may be selected for actual publication. However, when the viewer comes to the advertising server's webpage for that publication, a nearly limitless list of advertisers may be provided. Therefore, additional advertisers may be listed on this webpage who are relevant to the types of ads selected by the publisher. For example, if travel company ads were selected by the publisher, then the web page may list ads for other advertisers in the travel business. This benefits the viewer, because he/she is getting more selection, and it benefits the publisher and ad server portal because the potential for more click-through referral-based revenue generation is created. In various embodiments, when a user visits the publisher's web page, a real time auction may be conducted to determine exactly which advertisements appear on publisher's web page. That is more, less or different ads may appear than those that appeared in the published ad message. In various embodiments, this may be transparent to the person visiting the publisher's web page. In block 410, the viewer may query the advertiser database to either filter the current set of ads or to search for new ones. In various embodiments, if a new search is performed that ultimately results in a click-through referral, revenue generated by this referral may not be shared with the publisher because the scope of the original advertisement has been exceeded. In various other embodiments, all ad revenue generated by that viewer's activity originating form the publisher's web page may be shared between the ad server portal and the publisher. In block 415, operation returns to the method of FIG. 2, where, the viewer clicks on a hyperlink that takes him/her to the corresponding advertiser's website. Using well known web-based referral tracking techniques, a data record may be created acknowledging the fact that a user was directed to advertiser A's website from the publisher's web page. If the advertiser has a pricing contract specifying a fixed price per click-through referral or referral-based sale with the advertising server system, the advertiser may be charged accordingly.

Therefore, according to the various embodiments of the invention, traditional online retailers may benefit from web-based referrals that are initiated through published media advertising. Moreover, publishers may be able to sell incremental, unallocated space to a market not previously available to them on a “last minute” basis using an intuitive electronic ad server interface publisher. It is envisioned that the entity maintaining the advertising server may contract for payment from the advertisers and may pay a percentage of revenue realized to the publisher whose published ad messages are responsible for click-through referrals to the advertisers' websites, although this type of arrangement is not required. The publisher may maintain its own advertising server for contracting directly with advertisers.

### Exemplary Embodiment

Referring now to FIG. 6, an exemplary user interface screen shot of a publisher interface to an advertising server for selecting one or more advertisements according to according to at least one embodiment of the invention is depicted. In the example of FIG. 6, the exemplary publisher interface 500 is located at the http address “www.adservercompany.com/publicationA/login.asp” 'and is intended to be associated with a fictitious publication called the “Chicago Post Tribune.” However, it should be appreciated that using protocols other than HTTP, the address may be a keyword, number or other identifier. The interface window 500 may include a keyword input portion 510 that allows a publisher to supply one or more keywords and/or concepts related to ads that the publisher is seeking to use to fill available ad space in the publisher's publication. The interface 500 may also include other input portions that permit the publisher to specify a number of advertisers desired, a number of ad spaces desired, a dimension of each ad space and/or a placement location of each ad (i.e., marquis, back of publication, special advertising section, etc.). In this example, the publisher has supplied a keyword related to travel and a plurality of advertisers 520A, 520B, and 520C who supply travel related services are displayed by the ad server in the interface window 500. In various embodiments, a link is provided in the interface window 500 that permits the publisher to select the particular advertiser in a manner analogous to an Internet shopping cart. The interface may also include buttons 530, 540 that permit the publisher to preview his/her selections and to download the selections.

FIG. 7 is a sample publication advertisement message including information taken from portal-based advertisers according to at least one embodiment of the invention. The advertisement 600 of FIG. 7 includes advertiser information taken from ad server 610 that has been stripped down to remove any information identifying the particular advertisers whom the information is associated with. The information in this example is promoting cheap travel services. The ad message 600 may includes a URL 620 for a web page maintained by the ad server for the publication, as in the example of FIG. 6. The ad message 600 may also include an identifier for another type of electronic content such as a WAP identifier, phone number or broadcast frequency and/or channel. In this case, the advertiser content is specific to travel. In various embodiments, the ad server may maintain a variety of different content sites for each publication, wherein each content site is specific to a category of advertising. Therefore, viewers of the this publication ad 200 using an HTTP-based browser navigate to the URL “www.adservercompany.com/publicationA/travel” to obtain additional information on the featured advertisers. As noted herein the publication may actually be an Internet-based publication. In such embodiments, the ad message 600 would include a link such as one stating “Click here for more information on these and other advertisers.” In these embodiments, clicking the link may direct the viewer to the publication's web page on the ad server.

FIG. 8 is an exemplary user interface screen shot illustrating an exemplary view of a publisher's advertisement content page according to at least one embodiment of the invention. As noted herein, the viewer may access the advertiser content created for the publication through one of several different methods. In the case of an HTTP-based web browser, where the ad message includes a URL for the publisher's online advertising content, the viewer would navigate to “www.adservercompany.com/publicationA/travel.” In various embodiments, this content 700 is updated each time a new addition of the publication changes. In various embodiments, this content 700 is updated each time a relationship with one or more advertisers contracting with the advertising server is changed so that advertisers no longer paying for advertising do not receive free click-through referrals, regardless of whether their information appeared in the published ad message.

In this case the advertising content page 700 was created to put viewers in contact with travel related advertisers. The content page 700 includes links 710 to three different advertisers: www.travelcompanyA.com, www.travelcompanyB.com and www.travelcompanyC.com. The page 700 also includes a link to more travel deals which, when selected, may list links to other travel related advertisers in the advertiser database. In various embodiments, the page 700 may also include a query portion 720 that permits the viewer to perform his/her own queries of the advertiser database. In various embodiments, this may include preset filtering, such as limited only to narrowing results in the travel category. In various embodiments, this may allow the viewer to perform completely different searches having no relationship to travel or travel-related services. Though the ads depicted in the page 700 of FIG. 8 are textual only, it should be appreciated that they may include any combination of text and graphics, and may also provide a phone number, code or other method of tracking the referral in addition to, or instead of click-through tracking. In various embodiments, users may click on any of the hyperlinked descriptions and be automatically routed to the corresponding advertiser's website. In such a manner, the advertising server may collect revenue for advertising from the respective advertisers. Revenue may be based on simple click-through referrals or may be based on sales generated by customers accessing through the publisher's website. The particular pricing model used with the advertiser is not critical to the various embodiments of the invention. Rather, the various embodiments of the invention provide a way for variety of different Internet-type advertising pricing and usage models to be used to pay for publication-based click-through referrals.

Thus, the various embodiments for realizing click-through referral-based revenue from publication-based ad placement may benefit both advertisers and publishers. Furthermore, because an infinite number of websites may be created with relative ease, the system is not subject to the constraints of conventional systems that use a dedicated telephone number to track referrals. Also, publishers can obtain incremental advertising revenue on a short notice basis reaching a demographic that may not otherwise be willing to pay for publication ad space. Furthermore, free riding may be reduced by providing only the web address of the publishers' website maintained by the ad server and/or through other incentives, such as described in the aforementioned patent application, U.S. application Ser. No. 11/394,209.

It should be understood that the server, processors, and modules described herein may perform their functions (e.g., reading optical information or determining rating information) automatically or via an automated system. As used herein, the term “automatically” refers to an action being performed by any machine-executable process, e.g., a process that does not require human intervention or input.

The embodiments of the present inventions are not to be limited in scope by the specific embodiments described herein. For example, although many of the embodiments disclosed herein have been described with a publisher interface for filling unallocated publisher advertising space with Internet-based advertiser information thereby generating click-through referral-based revenue from publication-based ad placement, other embodiments, in addition to those described herein, should be apparent to those of ordinary skill in the art from the foregoing description and accompanying drawings. That is, Internet-based web page may not be only means of providing network accessible advertiser content for publishers. Publication ad messages may also include identifiers for text messaging sites, telephone numbers, streaming content sites, audio and/or video broadcast channels, chat sessions, automated email servers, etc. Thus, such modifications are intended to fall within the scope of the following appended claims. Further, although some of the embodiments of the present invention have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein. While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method of realizing revenue from publication-based advertisements comprising
providing a publisher interface adapted to permit selection of advertising information;
receiving a selection of advertising information;
providing the selected advertising information, including an identifier for the advertising information; and
tracking each time a viewer contacts an advertiser using the identifier.

2. The method according to claim 1, wherein providing a publisher interface comprises providing a network-based database of advertiser information.

3. The method according to claim 2, wherein the providing a publisher interface comprises providing an Internet-based database of advertiser information.

4. The method according to claim 2, wherein providing an Internet-based database of advertiser information comprises providing network identifiers for each advertiser included in the database.

5. The method according to claim 6, wherein providing an Internet-based database of advertiser information comprises receiving advertiser specified criteria and associating the advertising specified criteria with the advertiser information.

6. The method according to claim 5, wherein receiving advertiser specified criteria comprises receiving keyword associations specified by advertisers.

7. The method according to claim 2, wherein providing a publisher interface adapted to permit selection of advertising information comprises providing a query interface to the database adapted to receive search query criteria and to return advertising information in response to the query.

8. The method according to claim 7, wherein providing a query interface comprises providing an interface adapted to query the database based on one or more publisher-specified keywords.

9. The method according to claim 7, further comprising defining a correlation between keywords and advertising information in the database.

10. The method according to claim 7, wherein receiving a selection comprises receiving an indication of interest from the publisher for one or more units of the returned advertising information.

11. The method according to claim 10, wherein receiving an indication of interest for one or more units of the returned advertising information comprises receiving a selection of one or more advertisers.

12. The method according to claim 1, wherein providing the selected advertising information, comprises transferring information corresponding to the selection of advertising information to the publisher.

13. The method according to claim 12, wherein transferring comprises stripping out identifying information corresponding to the at least one selected advertisers prior to transferring;

14. The method according to claim 2, wherein providing a publisher interface adapted to permit selection of advertising information comprises providing an interface adapted to receive an input of a desired amount of available advertising space.

15. The method according to claim 14, wherein receiving a selection of advertising information comprises receiving an selection of advertising information to fill the desired amount of space.

16. The method according to claim 14, wherein providing the selected advertising information comprises generating one or more advertising messages adapted to conform to the desired amount of space.

17. The method according to claim 15, wherein providing the selected advertising information, including an identifier for the advertising information comprises creating network-based electronic content containing the selected advertising information and providing the network address of the electronic content as the identifier.

18. The method according to claim 17, wherein creating network-based electronic content containing the selected advertising information and providing the network address of the electronic content as the identifier comprises creating an Internet web-page containing the selected advertising information and providing Internet web page address as the identifier.

19. The method according to claim 17, wherein creating electronic content comprises providing a list of advertisement information taken from the database that is contextually relevant to the selected advertiser information.

20. The method according to claim 17, wherein tracking each time a viewer contacts an advertiser using the identifier comprises incrementing a counter each time a viewer contacts an advertiser from the network-based electronic content.

21. The method according to claim 20, further comprising incrementing an account when a viewer contacts a website associated with an advertiser from the electronic content.

22. The method according to claim 21, wherein incrementing an account comprises charging an account associated with the advertiser for the click-through referral to the advertiser's website.

23. A system for realizing click-through revenue from publication-based advertisements comprising:
an advertising server adapted to:
provide a publisher interface adapted to permit selection of advertising information;
transfer the advertising information to the publisher to be incorporated into a publication advertisement message, the publication advertisement message including an identifier; and
track viewer a referral from the publication advertisement message to an advertiser using the identifier.

24. An automated method for selling click-through referral-based advertising in published media comprising:
creating a database of advertisers;
receiving a request for advertisement information associated with a particular category;
providing a list of advertisement information based on the request;
receiving a selection of advertisement information from the list;
generating an advertisement message containing information corresponding to the selection;
transferring the advertisement message along with a network for the advertisement message;
generating electronic content at a location specified by the network identifier that contains the information corresponding to the selection; and
tracking a number of times viewers of the electronic content contact advertisers from the electronic content.
